(19) United States
(12) Patent Application Publication
(10) Pub. No.: US 2025/0377838 A1
(43) Pub. Date: Dec. 11, 2025

(54) IMAGE FORMATION SYSTEM

(71) Applicant: Konica Minolta, Inc., Tokyo (JP)

(72) Inventor: Hiroshi SEGUCHI, Tokyo (JP)

(21) Appl. No.: 19/219,679

(22) Filed: May 27, 2025

(30) Foreign Application Priority Data
May 29, 2024 (JP) 2024-087373

(51) Int. Cl. G06F 3/12; H04N 1/60

(52) U.S. Cl. CPC G06F 3/1208; G06F 3/1243; G06F 3/1256; H04N 1/6072

(57) ABSTRACT

A image formation system includes: an image processing device that generates colored image data and white image data from received print data; and an image forming device that prints the white image data and the colored image data.

### CROSS-REFERENCE TO RELATED APPLICATIONS

The entire disclosure of Japanese patent Application No. 2024-087373, filed on May 29, 2024, is incorporated herein by reference in its entirety.

### BACKGROUND OF THE INVENTION

### Technical Field

The present invention relates to an image formation system.

### Description of Related Art

When printing is performed on a medium having high transmittance such as a seal or a poster, the color of the medium may not be as desired depending on the location where the medium is attached, due to the influence of the color of the background. This can be avoided by, for example, printing the base with white ink so as not to be affected by the backgrounds.

When the data of base is printed in white ink, a dedicated object is required separately from the original document. In this case, a spot color is generated by a DTP (Desktop Publishing) application represented by Adobe (registered trademark), and is printed in white ink. This also requires specialized knowledge.

However, when an application such as Office (registered trademark) is used, simple pop and illustration can be created, but a spot color cannot be set by a process color. When the spot color cannot be set, data for white ink is generated separately from the document, and the data is printed in white ink. When the paper sheet printed with the white ink is printed again as a document by overprinting, the base can be printed, but there is a problem that a deviation occurs.

As a solution to such a problem, a color image forming device described in JP2002-268318A is known. The color image forming device described in JP2002-268318A reads an original image and forms a white toner image on the entire surface or a specific region.

The color image forming device described in JP2002-268318A reads a bitmapped original image and checks the density distribution of pixels and the density difference between adjacent dots, thereby determining whether the image is a photograph, characters, or line drawings and determining the range of formation of a white image. Therefore, for example, depending on the density of characters or line drawings and the density of their backgrounds, a deviation from the formation range of the white image may occur, and the formation range of the white image may become inappropriate.

For example, depending on the density of the characters or line drawings and their backgrounds, it may be difficult to determine which are the characters, and it may be difficult to see them.

### SUMMARY OF THE INVENTION

The present invention has been made in view of the above problems. The object of the present invention is to provide an image formation system that can appropriately form a white image even for data in which characters or line drawings and their backgrounds are difficult to distinguish.

To achieve at least one of the abovementioned objects, according to an aspect of the present invention, an image formation system comprises: an image processing device that generates colored image data and white image data from received print data; and an image forming device that prints the white image data and the colored image data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram showing an outline of an image formation system according to an embodiment of the present invention.

FIG. 2 is a block diagram showing the image formation system according to the embodiment of the present invention.

FIG. 3 is a conceptual diagram of a medium on which a white undercoat image is printed.

FIG. 4 is a flowchart showing the image formation system according to the embodiment of the present invention.

FIG. 5A is a schematic diagram showing an example of the display part and the operation part of the operation panel when the white undercoat is set.

FIG. 5B is a schematic diagram showing an example of the display part and the operation part of the operation panel in the white undercoat object.

FIG. 5C is a schematic diagram showing an example of the display part and operation part of the operation panel in the white undercoat printing plate.

FIG. 5D is a schematic diagram showing an example of the display part and the operation part of the operation panel when the range setting is performed.

FIG. 6 is a flowchart showing the operation of the white image forming part.

FIG. 7 is a transmittance information database showing the transmittance density of various media.

FIG. 8 is a flowchart showing the operation of the white image combining part.

### DETAILED DESCRIPTION OF THE EMBODIMENTS

Hereinafter, one or more embodiments of the present invention will be described with reference to the drawings. However, the scope of the invention is not limited to the disclosed embodiments.

Next, an embodiment of the present invention will be described in detail with reference to the drawings as appropriate. In the drawings, the same reference numerals are given to the same members.

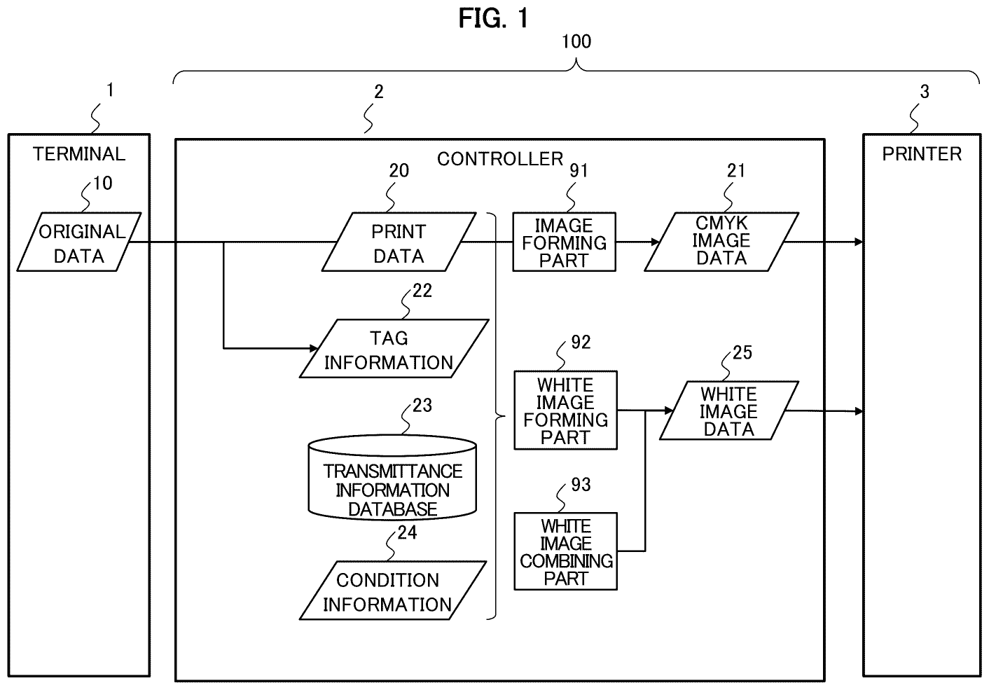

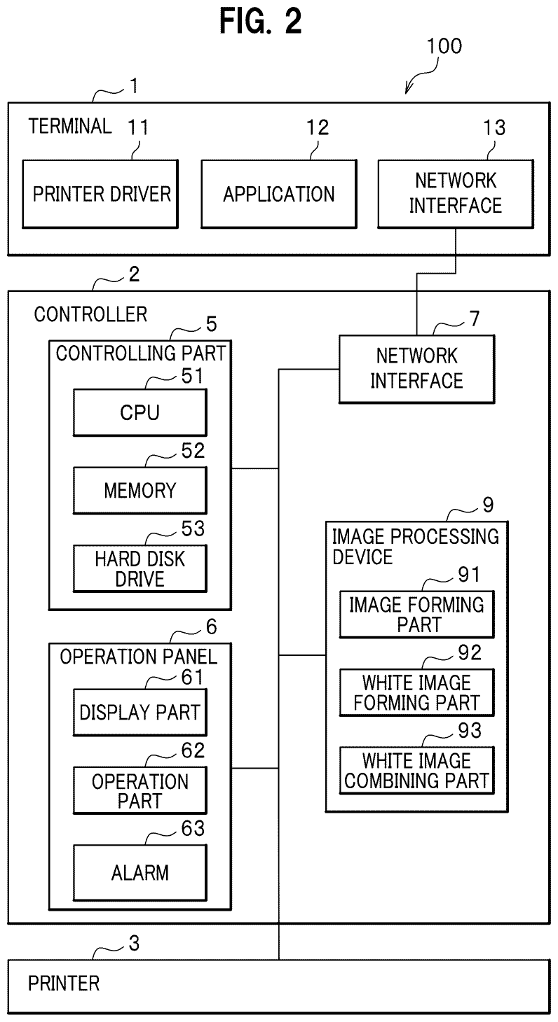

FIG. 1 is a schematic diagram showing an overview of an image formation system 100 according to an embodiment of the present invention. FIG. 2 is a block diagram of the image formation system 100 according to the embodiment of the present invention.

### <<Image Formation System>>

As shown in FIG. 1, the image formation system 100 is a device that automatically generates white image data 25 from original data 10 based on a print job received from a terminal 1, and performs white undercoat printing on a recording medium. The image formation system 100 includes a controller 2 and a printer 3. The image formation system 100 generates print data 20 described in a page description language (PDL) from original data 10 using an application 12, a printer driver 11, or the like from a terminal 1 operated by a user, and a controller 2 receives the print data 20 via a network interface 13.

### <<Terminal>>

The terminal 1 is an input terminal of Internet communication, and is a device with which a user inputs and outputs data. The terminal 1 is composed of a personal computer, a smartphone, a tablet, or the like. The terminal 1 generates print data 20 described in PDL from the original data 10 and transmits the print data 20 to the controller 2. As shown in FIG. 2, the terminal 1 includes a printer driver 11, an application 12, and a network interface 13.

The printer driver 11 is software necessary for printing by connecting the terminal 1 to the printer 3.

The application 12 is a program for operating the terminal 1.

The network interface 13 is a communication interface for transmitting and receiving data of the terminal 1 to and from the controller 2.

### <Original Data>

The original data 10 shown in FIG. 1 includes character data, line drawing data, background data, and the like.

### <Medium>

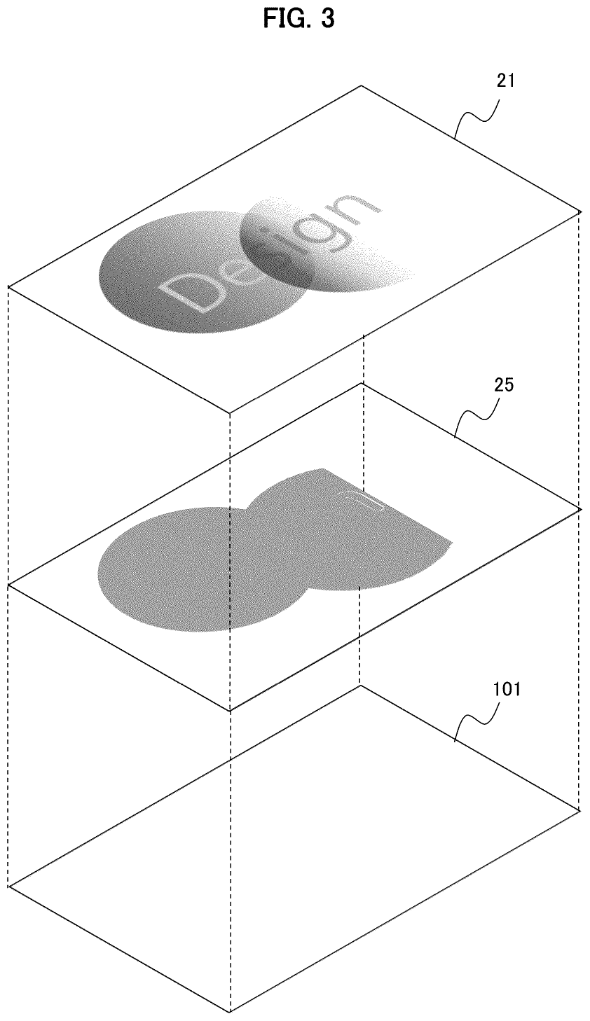

FIG. 3 is a conceptual diagram of a medium 101 on which a white undercoat image is printed.

The medium 101 used in the image formation system 100 is a recording medium that can be recorded and saved. The medium 101 may have a relatively high transmittance, may be capable of forming an image on the front side, and may be usable as a recording medium. The medium 101 is, for example, a plastic film, a seal, a glass plate, paper sheet, or the like.

On the medium 101, white image data 25 is printed as a base, and then CMYK image data 21 is printed. This makes it possible to prevent the medium 101 from being affected by the background of the place where the medium 101 is attached even when the transparency of the medium 102 is high.

### <<Controller>>

The controller 2 converts the original data 10 received from the terminal 1 into actual drawing data and controls each unit of the printer 3. The controller 2 receives the print data 20 described in the PDL from the terminal 1 and sends the print data 20 to the image forming part 91. The print data 20 sent to the image forming part 91 is converted into CMYK image data 21, which is raster data, and tag information 22 by a raster image processor (RIP) process by the image forming part 91. Further, the controller 2 automatically generates white image data 25 from the conditions of the CMYK image data 21 and the tag information 22 by condition setting 24, and transmits the white image data 25 to the printer 3.

The CMYK image data 21 shown in FIG. 1 is data obtained by rasterizing the print data 20. The CMYK image data 21 is composed of pixels arranged in a lattice pattern.

The tag information 22 is information tagged to each data item. The tag information 22 has object information classified into texts, graphics, and images on the document and color space information of each object information in 1 byte.

The transmittance information database 23 for each medium is information such as transmittance for each of various media 101. The transmittance information database 23 for each medium is stored in the memory 52 (see FIG. 2).

The condition setting 24 is a setting of conditions such as selection of an object, selection of a plate, an unnecessary portion of white ink, setting of a job, setting of both sides (front side and back side), and setting of a security pattern. White image data 25 is generated based on the CMYK image data 21, the tag information 22, and the condition setting 24.

### <<Printer>>

The printer 3 shown in FIG. 1 is an image forming device for printing white undercoat data on a recording medium without print deviation from the CMYK image data 21, the white image data 25, and the condition setting 24 from the controller 2. The printer 3 may be an electrophotographic image forming device that forms a toner image, or may be a device of another type such as an inkjet type.

### <<Details of Controller>>

The controller 2 shown in FIG. 2 includes a controlling part 5, an operation panel 6, a network interface 7, and an image processing device 9. The controller 2 is connected to the printer 3 and performs printing using the printer 3.

### <<Controlling Part>>

The controlling part 5 converts the received print data 20 from the terminal 1 into CMYK image data 21 and tag information 22. The controlling part 5 further generates white image data 25 from the CMYK image data 21, the tag information 22, and the condition setting 24. The controlling part 5 is a computer (not shown) that controls the operation of each functional unit such as the operation panel 6, the network interface 7, and the image processing device 9. The controlling part 5 controls the operations of the operation panel 6 and the image processing device 9 based on the operation of the operation panel 6 and the received signal from the terminal 1, and controls the operation of the printer 3 by determining the object from the print job. The controlling part 5 adjusts the color of the image, the position of the image, the register mark, etc., based on the print data 20 from the terminal 1. The controlling part 5 includes a central processing unit (CPU) 51, a memory 52, and a hard disk drive (HDD) 53. The memory 52 is, for example, a read only memory (ROM) or a random access memory (RAM).

### <CPU>

The CPU 51 shown in FIG. 2 reads a program corresponding to the process content from the hard disk drive 53, expands the program in a RAM (not shown), and executes the expanded program, thereby controlling each component of the image formation system 100. At this time, the CPU 51 refers to various data stored in the memory 52 and the hard disk drive 53.

### <Memory>

The memory 52 is a first storage that stores information related to the image formation system 100. The memory 52 stores the transmittance of the medium 101, image data, and the like.

### <Hard Disk Drive>

The hard disk drive 53 is a nonvolatile storage capable of storing a large amount of image data and various programs, and is a second storage. The hard disk drive 53 stores the print data 20 transmitted from the terminal 1, and stores the CMYK image data 21, the white image data 25, and the like that have been output.

### <<Operation Panel>>

The operation panel 6 shown in FIG. 2 is formed of, for example, a touch panel display in which a touch panel is stacked on the upper side of a liquid crystal display. The operation panel 6 is used for inputting various settings such as printing conditions and execution timing of adjustment of the formation position of front and back images, displaying the state of the device, and inputting various instructions. The operation panel 6 receives selection of a plate and displays a determination result of the controlling part 5. The operation panel 6 includes a display part 61, an operation part 62, and an alarm 63.

The operation panel 6 may display an image formed by the image formation system 100 or other images.

### <Display Part>

The display part 61 is a display device for displaying the content of the operation in the operation part 62, and is formed of, for example, a liquid crystal display. The display part 61 displays information of the image formation system 100, information of the state of the medium 101, an automatically generated white ink image, and the like.

### <Operation Part>

The operation part 62 is an input device for inputting settings of a job to be executed using the image formation system 100. The operation part 62 is formed of, for example, a touch panel. The operation part 62 selects an object. The user may input medium information for various media 101 via the operation part 62. The medium information includes type, material, thickness, size, and the like of the medium 101. The medium information input in the operation part 62 is stored in the memory 52.

### <Alarm>

The alarm 63 is a voice alarm that notifies the user by voice. The alarm 63 is formed of, for example, a speaker.

### <Network Interface>

A network interface 7 shown in FIG. 2 is a communication interface for transmitting and receiving information to and from an external device. The network interface 7 receives the print data 20 from the terminal 1 and transmits the print data 20 to each unit of the controller 2 in accordance with an instruction from the controlling part 5.

### <<Printer>>

The printer 3 is a device that prints an image on the medium 101 based on the set printing conditions.

### <<Image Processing Device>>

The image processing device 9 shown in FIG. 2 is a device for setting and controlling the density of the white image data 25 automatically generated from the transmittance of the medium 101 and the print density of the job. The image processing device 9 enables the print density of the job and the density of the white ink to be set up to the toner amount limit value of the image processing device 9.

### <Image Forming Part>

The image forming part 91 is a device for forming white undercoat data on the recording medium of the printer 3. The image forming part 91 does not generate the ink image outside the register mark.

### <White Image Forming Part>

The white image forming part 92 is a device for generating the white image data 25 of the selected plate. The white image forming part 92 controls the density of the white image data 25 that is automatically generated. The white image forming part 92 sets the density of the white image data 25 from the transmittance of the medium 101 and the print density of the job. The white image forming part 92 has a function of making the white ink density of all data uniform. The white image forming part 92 forms the white image data 25 by the CMYK image data 21, the tag information 22, and the following conditions 1 to 3.

### <Condition 1>

The information obtained by the image forming part 91 is notified to the user, and the condition is set by the input from the user.

The CMYK plate to be output may be pressure-bonded using CMYK toner in hot foil stamping or the like, and it is not necessary to perform white undercoat on the premise thereof.

The object to be output may be designed to be transparent, and can be set as desired by selecting the object.

The range to be output can be made to correspond to a plurality of media and designs by forming a range in which a white image is not generated.

### <Condition 2>

When the job setting is both sides, pages of front and back sides are collated, and since the transmittance of the overlapping portion of the front and back sides is low, a white image is not generated. When the security pattern is set, the white image data 25 generated by the white image forming part 92 and the security pattern are combined.

### <Condition 3>

The controller 2 has a transmittance information database 23 for each medium 101, and determines the density of the white image from the transmittance information database 23 for each medium 101.

In the case of the undefined medium 101, information of the maximum toner density of the engine is also referred to.

When the variable data is received, the white image data 25, which is the master data, is stored, and the white image data 25 is formed while the variable data is combined.

The CMYK image data 21 generated by the image forming part 91 and the white image data 25 generated by the white image forming part 92 are transmitted to the printer 3.

### <White Image Combining Part>

The white image combining part 93 shown in FIG. 2 is a device for acquiring a security pattern or a stamp on the image processing device 9 side and combining the security pattern or the stamp with the white image data 25. In variable printing, the white image combining part 93 generates a common portion and combines the common portion with a variable portion.

### <<Operation of Entire Image Formation System>>

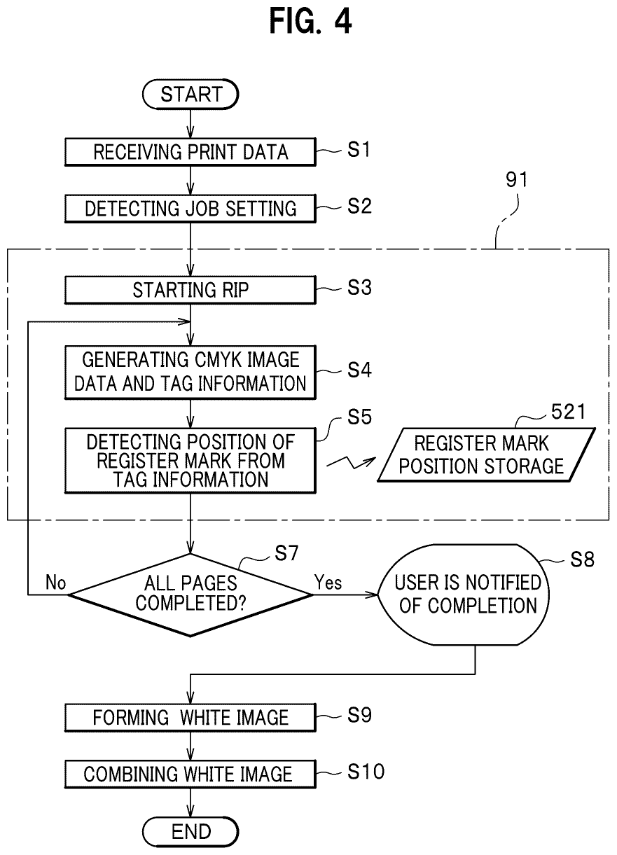

FIG. 4 is a flowchart showing the operation of the image formation system 100 according to the embodiment of the present invention.

Next, the operation of the entire image formation system 100 will be described mainly with reference to FIG. 1 to FIG. 5D.

First, as shown in FIG. 1, the user operates the terminal 1 to generate print data by using the application 12, the printer driver 11, and the like. The controller 2 receives the print data 20 described in PDL from the terminal 1 via the network interfaces 13 and 7 (step S1), and detects the job setting (step S2).

Next, the image forming part 91 shown in FIG. 2 starts RIP (rasterization) (step S3). Subsequently, the image forming part 91 generates the RIP-processed CMYK image data 21 and the tag information 22 (step S4). Subsequently, the image forming part 91 detects the position of the register mark from the tag information 22, and determines the range of outputting the white image data 25 for each page (step S5). When the position of the register mark cannot be detected, the full bleed is performed. Then, in step S5, the image forming part 91 stores the detected position of the register mark of each page in the register mark position storage 521 of the memory 52.

Next, the image forming part 91 scans the tag information 22 and stores a position where color information (Separation All) used as a register mark is detected in a table. Subsequently, the image forming part 91 confirms whether or not the reception of all pages of the original data 10 is completed (step S7). If there is a page of the original data 10 that has not been received (No), the process returns to step S4. If all the pages of the original data 10 have been completed (Yes), the process proceeds to step S8.

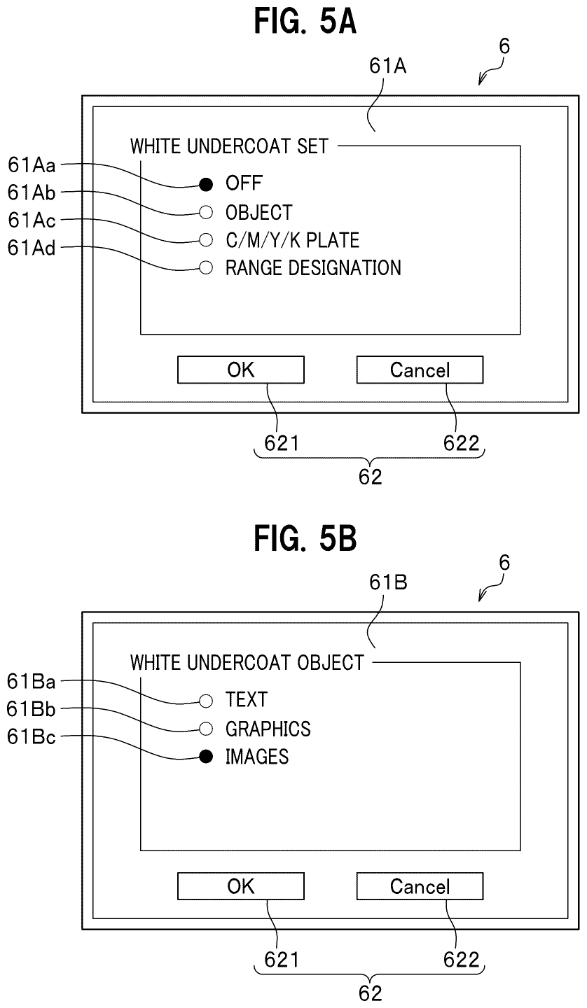

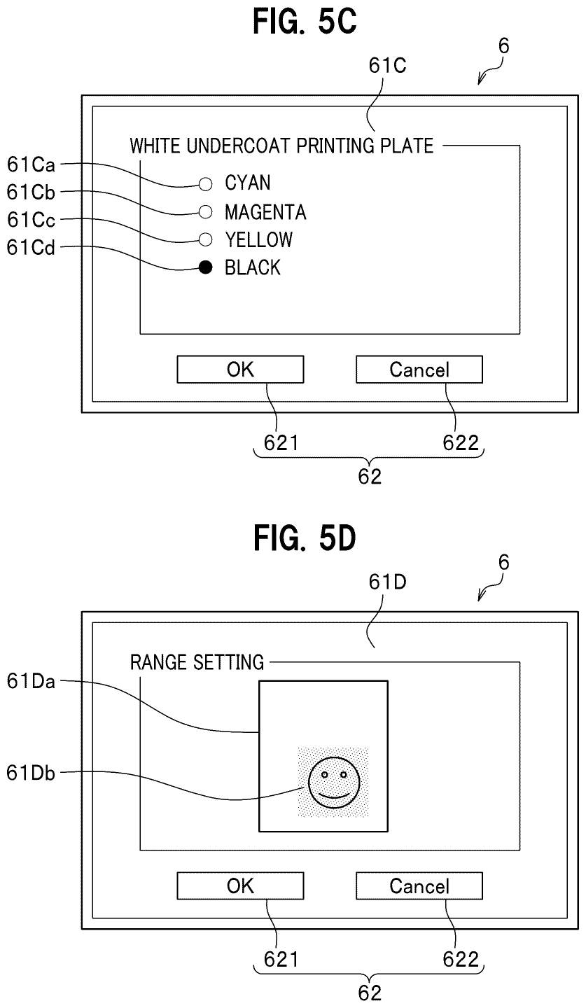

FIG. 5A is a schematic diagram showing an example of the display part 61A and the operation part 62 of the operation panel 6 when the white undercoat is set. In the display part 61A of the operation panel 6 of the white undercoat setting shown in FIG. 5A, an OFF radio button 61Aa, an object radio button 61Ab, a C/M/Y/K plate radio button 61Ac of cyan, magenta, yellow, and black, and a range designation radio button 61Ad are displayed. The operation part 62 includes an OK button 621 and a Cancel button 622.

FIG. 5B is a schematic diagram showing an example of the display part 61B and the operation part 62 of the operation panel 6 in the white undercoat object. When the user selects the object radio button 61Ab of the display part 61A shown in FIG. 5A, the operation panel 6 is switched to the display part 61B of the white undercoat object shown in FIG. 5B. In the display part 61B, a text radio button 61Ba for displaying only text, a graphic radio button 61Bb for displaying only graphics, and an image radio button 61Bc for displaying only images are displayed.

FIG. 5C is a schematic diagram showing an example of the display part 61C and the operation part 62 of the operation panel 6 in the white undercoat printing plate. When the C/M/Y/K plate radio button 61Ac of the display part 61A shown in FIG. 5A is selected, the operation panel 6 is switched to the display part 61C of the white undercoat printing plate shown in FIG. 5C. In the display part 61C, a cyan radio button 61Ca for displaying only cyan, a magenta radio button 61Cb for displaying only magenta, a yellow radio button 61Cc for displaying only yellow, and a black radio button 61Cd for displaying only black are displayed.

FIG. 5D is a schematic diagram showing an example of the display part 61D and the operation part 62 of the operation panel 6 when the range setting is performed. When the range designation radio button 61Ad of the display part 61A shown in FIG. 5A is selected, the operation panel 6 is switched to the display part 61D of the range specification shown in FIG. 5D. In the display part 61D, a design region 61Da indicating entire design and an area 61Db indicating a specified range are displayed.

Next, when all pages of the original data 10 are completed, the user is notified of the completion by an alarm 63. Further, the object of the white undercoat (see FIG. 5B), the white undercoat printing plate (see FIG. 5C), and the condition setting 66 of the range setting (see FIG. 5D) are performed (step S8).

Subsequently, the received image is sent to the white image forming part 92 (step S9), and is sent to the white image combining part 93 (step S10), and the process is terminated.

### <<Operation of Entire Image Forming System>>

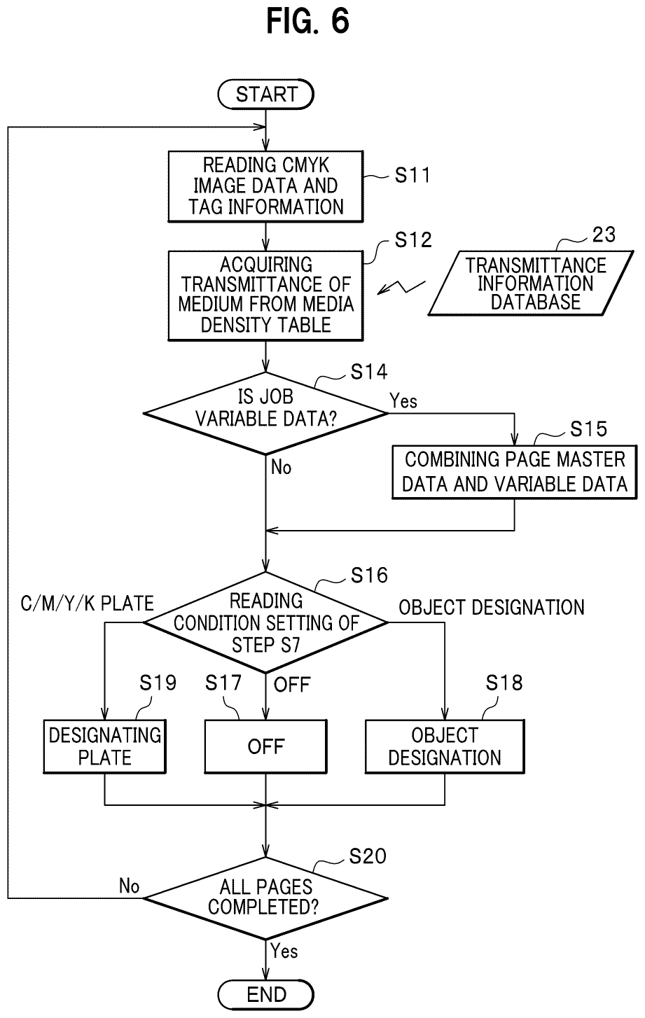

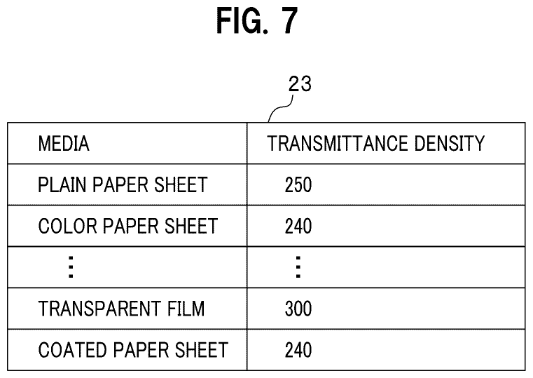

FIG. 6 is a flowchart showing the operation of the white image forming part 92. FIG. 7 is a transmittance information database 23 showing the transmittance density N of various media 101.

The overall operation of the image formation system 100 will now be described with reference to FIG. 1, FIG. 2 and FIG. 6.

First, the controller 2 reads the CMYK image data 21 and the tag information 22 (step S11). Next, the controller 2 acquires the transmittance of the medium 101 from the transmittance information database 23 (step S12), and determines the density of the medium 101 being used. If the engine maximum density is undefined, the engine maximum density is uniformly set.

FIG. 7 is a transmittance information database 23 showing the transmittance density N of various media 101.

The transmittance density N of the medium 101 is a density obtained by adding a density that is not transparent in the density of white to the CMYK image data 21. The transmittance information database 23 includes a medium column and a medium transmittance density column. As shown in FIG. 7, for example, the transmittance density N of the plain paper sheet is 250%. The transmittance density N of the color paper sheet is 240%. The transmittance density N of the transparent film is 300%. The transmittance density N of the coated paper sheet is 240%.

Subsequently, the white image forming part 92 of the controller 2 confirms whether the job is variable data (step S14). That is, the confirmation is performed by the type of the PDL or the type of the job.

If the job is variable (Yes in step S14), the process proceeds to step S15, and the white image forming part 92 combines the page master data and the variable data. That is, the white image forming part 92 combines the master data (unchanged part) and the variable data (part) of the rasterized page according to the position of the job setting.

If the job is not variable data, the process proceeds to step S16, and the white image forming part 92 reads each condition setting 24 of step S7 in FIG. 4 and makes a determination.

In step S16, when the condition of the condition setting 24 is “Off”, the white image forming part 92 turns off the condition setting 24 and generates the white image data 25 (step S17). Specifically, the white image forming part 92 sequentially scans the CMYK image data 21, calculates the white image pixel density from the same position of each pixel of the raster data plate, and generates the white image.

For example, when the transmittance density of the medium 101 is N, the white density to be printed on the medium 101 is calculated by subtracting the cyan density, the magenta density, the yellow density, and the black density from the transmittance density N.

In step S16, when the condition of the condition setting 24 is “object designation”, the white image forming part 92 generates the white image data 25 by the object designation (step S18). Specifically, the white image forming part 92 scans the CMYK image data 21 and the tag information 22 in order, and calculates the white image pixel density at the same position in the case of each pixel of the raster data plate and the object designated from the object information of the tag information 22, thereby generating the white image data 25. When the object is not the designated object, the white image forming part 92 skips generation of the white image data.

In step S16, when the condition of the condition setting 24 is “C/M/Y/K plate”, the white image forming part 92 designates a plate (step S19). Specifically, the white image forming part 92 sequentially scans the CMYK image data 21, calculates each pixel density of the white image from the same position of each pixel of the raster data plate, and generates the white image data 25. For a plate that is not specified, each plate in the density calculation formula is set to 0.

In step S20, the white image forming part 92 determines whether or not the process of all pages of the print job is completed. If all pages have not been completed (No in step S20), the process returns to step S11. When all pages are completed (Yes in step S20), the process is terminated.

### <<Operation of White Image Combining Part>>

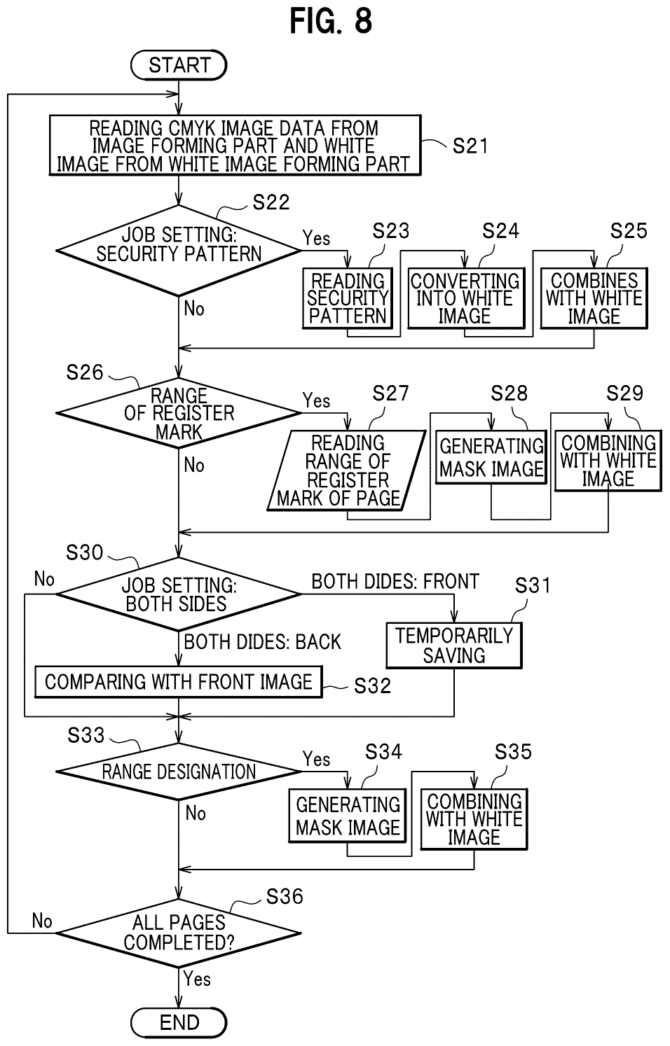

FIG. 8 is a flowchart showing the operation of the white image combining part 93. Next, the operation of the white image combining part 93 will be described with reference to FIG. 1, FIG. 2 and FIG. 8.

First, the white image combining part 93 reads the CMYK image data 21 from the image forming part 91 and the white image from the white image forming part 92 (step S21). Next, the white image combining part 93 confirms the security pattern in the job setting (step S22). When there is no job setting (No in step S22), the process proceeds to step S26. If the job setting is set (Yes in step S22), the process proceeds to step S23, and the white image combining part 93 reads the security pattern (step S23). Subsequently, the white image combining part 93 converts the security pattern into a white image by gray scaling (step S24).

In the case of gray scale conversion, a general calculation formula is used. The conversion formula from the CMYK image data 21 to the gray scale is, for example, the following formula (1).

$${D}_{g} = 1. - min ( 1. , 0.3 {D}_{c} + 0.59 {D}_{m} + 0.11 {D}_{y} ) \qquad ( 1 )$$

where
Gray scale density: D_{g}
Cyan density: D_{c}
Magenta density: Dₘ
Yellow density: D_{y}

Next, the white image combining part 93 combines the gray-scaled image and the white image read in step S21 (step S25), and the process proceeds to step S26.

Next, the white image combining part 93 determines whether or not the range of the register mark data detected in step S26 of FIG. 4 is set. If the range of the register mark data is not set (No), the process proceeds to step S26. When the range of the register mark is set (Yes in step S26), the white image combining part 93 reads the range of the register mark data of the page (step S27).

Subsequently, the white image combining part 93 generates a mask image with the page size of the page from the read range (step S28). The white image combining part 93 combines the white image of the step S21 or the step S25 with the mask image of the step S25 and deletes an unnecessary portion (step S29).

Next, the white image combining part 93 confirms the job setting (step S30). When the job setting is not both sides (No in step S30), the process proceeds to step S33. When the job setting is both sides and front side, the white image combining part 93 temporarily saves the white image on the front side for comparison with the back side (step S31), and the process proceeds to step S33.

In a case where the job setting is the back side, the white image combining part 93 refers to the transmittance density N of the medium 101, and when the white image of the back side is acquired, the white image combining part 93 scans and compares the same position as the front side image saved in step S31, and the process proceeds to step S33. In this scan, if the pixels of each front and back sides do not overlap, the process skips the generation of white image data, and the following is performed to reduce the white image in the portion where the front and back sides overlap.

The white image generated by the white image forming part 92 up to this point satisfies the transmittance density N of the medium on both the front and back sides.

The white image combining part 93 removes the white image pixels on the back side. Then, the white image combining part 93 recalculates the white image pixels on the front side.

A case where the density of the raster data of the front and back sides is greater than the transmittance density N of the medium is shown in the following formula (2).

$$N < ( {D}_{c 0} + {D}_{m 0} + {D}_{y 0} + {D}_{k 0} ) + ( {D}_{c 1} + {D}_{m 1} + {D}_{y 1} + {D}_{k 1} ) \qquad ( 2 )$$

where
Transmittance density of medium: N
Cyan density of front side: D_{c0}
Front side magenta density: Dₘ₀
Front side yellow density: D_{y0}
Black density of front side: Dₖ₀
Cyan density of back side: D_{c1}
Magenta density of back side: Dₘ₁
Yellow density of back side: D_{y1}
Black density of back side: Dₖ₁

At this time, the white image pixels on the front side may be removed.

A case where the density of the CMYK image data 21 of the front and back sides is smaller than the transmittance density N of the medium 101 is shown in the following formula (3).

$$N > ( {D}_{c 0} + {D}_{m 0} + {D}_{y 0} + {D}_{k 0} ) + ( {D}_{c 1} + {D}_{m 1} + {D}_{y 1} + {D}_{k 1} ) \qquad ( 3 )$$

The white pixel value of the front side is shown in the following formula (4).

$${D}_{w 0} = N - \{ ( {D}_{c 0} + {D}_{m 0} + {D}_{y 0} + {D}_{k 0} ) + ( {D}_{c 1} + {D}_{m 1} + {D}_{y 1} + {D}_{k 1} ) \} \qquad ( 4 )$$

where
Front side white pixel values: D_{w0}

In step S33, the white image combining part 93 determines whether or not a range has been specified in step S8 of FIG. 3. If no range is specified (No), the process proceeds to step S36.

When the range is specified (Yes), the white image combining part 93 reads the specified range from the setting and generates a mask image (step S34). Next, the white image combining part 93 combines the mask image and the white image, and removes the specified range (step S35), and then the process proceeds to step S36.

In step S36, the white image combining part 93 determines whether or not the scanning of all pages is completed. If the scanning of all pages is not completed (No), the process returns to step S21. If the scanning of all pages is completed (Yes), the process of FIG. 7 is terminated.

As described above, the image formation system 100 of the present invention includes the image processing device 9 that generates the colored image data and the white image data 25 from the received print data 20, and the image forming device (printer 3) that prints the white image data 25 and the colored image data, as shown in FIG. 1 or FIG. 2.

According to this configuration, the image formation system 100 generates the white image data 25 from the print data 20 based on the print job and controls the white undercoat printing, so that there is no deviation from the white ink even in the data in which characters, line drawings, backgrounds, and the like are difficult to be distinguished. Therefore, the present invention does not require additional printing, and thus can reduce the defective rate of printing and reduce the cost.

As shown in FIG. 2, the image processing device 9 includes a white image forming part 92 that controls the density of the white image data 25.

According to this configuration, the image processing device 9 can control the density of the white image data 25 by including the white image forming part 92, and thus the defective rate of printing is reduced.

As shown in FIG. 2, the white image forming part 92 sets the density of the white image data 25 from the transmittance of the medium to be printed and the print density of the colored image data.

According to this configuration, since the white image forming part 92 can set the density of the white image data 25, the density of the white ink can be adjusted, and thus the quality of the printed matter is improved. In addition, by appropriately setting the density, it is possible to ensure uniform application of the white ink and color reproducibility. In particular, in the printing of photographs and graphics, by appropriately setting the density of white ink, brightness and contrast can be adjusted, and clear and beautiful printed matter can be created. Further, by appropriately setting the density of white ink, the visibility and effect of the printed matter are maximized.

As shown in FIG. 2, the white image forming part 92 enables the print density of the colored image data and the density of the white image data 25 to be set up to the toner amount limit value of the image processing device 9.

According to this configuration, the white image forming part 92 can set the print density of the colored image data and the density of the white image data 25 up to the toner amount limit value of the image processing device 9, and thus the density and the white ink can be flexibly adjusted by the image processing device 9. Therefore, the white image forming part 92 improves the diversity of the printed matter. Accordingly, the white image forming part 92 can optimize the combination of density and white ink to make an attractive design when printing a photograph or an illustration in a poster or a pamphlet, for example. Therefore, the white image forming part 92 adjusts the print density and the white ink up to the toner amount limit value, thereby improving the quality and diversity of the printed matter.

As shown in FIG. 2, the white image forming part makes the density of the white image data uniform.

According to this configuration, the white image forming part 92 can make the density of the white image data 25 uniform, and therefore, an image with a stable white ink density can be printed at all times.

In addition, when printing is performed on a colored medium 101 (for example, in the case of a colored paper sheet) as it is, the color of the medium 101 is mixed, and the color of the ink is not clearly shown. In this case, by printing with white ink, the color of the ink is clearly exhibited while exhibiting the texture of the colored paper sheet. That is, the white image forming part 92 first prints the white ink on a portion where the color is desired to be clearly shown, and then performs color printing thereon, so that the color of the ink is clearly shown as if the ink is printed on white paper even in the medium 101 or the material which is difficult to develop color.

In addition, for example, in a case where characters, logos, illustrations, or the like are printed on black paper with white ink, printed matter with impact can be created.

As shown in FIG. 2, the image formation system 100 includes an image forming part 91 that generates colored image data inside the register mark and does not generate colored image data outside the register mark.

According to this configuration, since the image formation system 100 has the image forming part 91, the ink image can be always printed inside the register mark, and thus it is possible to prevent the ink image from being printed outside the register mark.

As shown in FIG. 2, the image formation system 100 includes a white image combining part 93 that acquires a security pattern or a stamp on the image processing device 9 side and combines the security pattern or the stamp with the white image data 25.

According to this configuration, the white image combining part 93 can acquire the security pattern or stamp on the image processing device 9 side and combine the acquired security pattern or stamp with the white image data 25, thereby improving the aesthetic appearance and reliability.

As shown in FIG. 2, the colored image data includes a plurality of color image data, and the white image forming part 92 generates the white image data 25 based on the selected color image data.

According to this configuration, the white image forming part 92 can generate the white image data 25 from the selected color image data, and thus, a clear contrast is generated, and text, a figure, and the like are emphasized so as to be conspicuous.

As shown in FIG. 2, the image formation system 100 includes an operation part 62 that receives selection of color image data constituting the colored image data.

According to this configuration, the image formation system 100 can select color image data desired by the user by including the operation part 62.

As shown in FIG. 2, the white image forming part 92 determines an object from the print data 20.

According to this configuration, the image formation system 100 includes the white image forming part 92, and thus, it is possible to display and confirm the determination result of the object from the print data 20.

As shown in FIG. 2, the image formation system 100 includes an operation part 62 that selects an object.

According to this configuration, the image formation system 100 includes the operation part 62, and thus the user can select a desired object.

As shown in FIG. 2, the image formation system 100 includes a display part 61 that displays the generated white image data 25.

According to this configuration, the image formation system 100 includes the display part 61, and thus displays the generated white image data 25 to notify the user of the state of the white image.

As shown in FIG. 2, the image formation system 100 includes an operation part 62 that receives an unnecessary portion of white ink.

According to this configuration, the image formation system 100 includes the operation part 62, thereby receiving and removing an unnecessary portion of white ink, and thus obtaining a desired white ink image.

As shown in FIG. 2, the image formation system 100 includes a white image forming part 92 that does not generate a white ink image for data overlapping the back side when the print job is the both sides.

According to this configuration, when the print job is the both sides, the white image forming part 92 does not generate the white ink image in the data overlapping the back side, and thus both side surfaces of one medium 101 can be effectively used. Therefore, when printing is performed, the waste of the medium 101 can be reduced, and the cost can be reduced.

As shown in FIG. 2, the image formation system 100 includes a white image combining part 93 that generates a common portion and combines the common portion with a variable portion in variable printing.

According to this configuration, the white image combining part 93 can generate the common portion and combine the common portion with the variable portion in the variable printing, and thus, it is possible to print while appropriately changing the information to be printed based on the original data 10, which is convenient.

### Modifications

Although embodiments of the present invention have been described and illustrated in detail, the disclosed embodiments are made for purposes of illustration and example only and not limitation. The scope of the present invention should be interpreted by terms of the appended claims.

What is claimed is:

1. A image formation system, comprising:
an image processing device that generates colored image data and white image data from received print data; and
an image forming device that prints the white image data and the colored image data.

2. The image formation system according to claim 1, wherein
the image processing device includes a white image forming part that controls a density of the white image data.

3. The image formation system according to claim 2, wherein
the white image forming part sets a density of the white image data from a transmittance of a medium to be printed and a print density of the colored image data.

4. The image formation system according to claim 2, wherein
the white image forming part enables a print density of the colored image data and the density of the white image data to be set up to a toner amount limit value of the image processing device.

5. The image formation system according to claim 2, wherein
the white image forming part makes the density of the white image data uniform.

6. The image formation system according to claim 1, further comprising:
an image forming part that generates the colored image data inside a register mark and does not generate the colored image data outside the register mark.

7. The image formation system according to claim 2, further comprising:
a white image combining part that acquires a security pattern or a stamp on the image processing device side and combines the security pattern or the stamp with the white image data.

8. The image formation system according to claim 2, wherein
the colored image data includes a plurality of color image data, and
the white image forming part generates the white image data based on the selected color image data.

9. The image formation system according to claim 8, further comprising:
an operation part that receives selection of color image data constituting the colored image data.

10. The image formation system according to claim 2, wherein
he white image forming part determines an object from the print data.

11. The image formation system according to claim 10, further comprising:
an operation part that selects the object.

12. The image formation system according to claim 1, further comprising:
a display part that displays the generated white image data.

13. The image formation system according to claim 12, further comprising:
an operation part that receives an unnecessary part of white ink.

14. The image formation system according to claim 1, further comprising:
a white image forming part that does not generate a white ink image for data overlapping the back side when the print job is the both sides.

15. The image formation system according to claim 1, further comprising:
a white image combining part that generates a common portion and combines the common portion with a variable portion in variable printing.
